(19) United States
(12) Patent Application Publication
(10) Pub. No.: US 2012/0080820 A1
(43) Pub. Date: Apr. 5, 2012

(54) IMPRINTING METHOD

(75) Inventors: Shintarou Narioka, Utsunomiya-shi (JP); Keiji Emoto, Saitama-shi (JP); Tsuyoshi Arai, Utsunomiya-shi (JP)

(73) Assignee: CANON KABUSHIKI KAISHA, Tokyo (JP)

(21) Appl. No.: 13/248,226

(22) Filed: Sep. 29, 2011

(30) Foreign Application Priority Data
Oct. 4, 2010 (JP) 2010-224819

(51) Int. Cl. B29C 59/02

(52) U.S. Cl. 264/293

(57) ABSTRACT

Provided is an imprinting method for transferring a pattern formed on a mold to a substrate, the imprinting method including applying a resin to a predetermined shot area on the substrate; moving the shot area from an application position to an imprinting position; supplying gas to the shot area; and imprinting the mold into the shot area, wherein, in the gas supply step, gas is supplied only from a gas supplying unit located above a moving path extending from the application position to the imprinting position, and the supply of the gas is started before the shot area passes beneath the gas supplying unit to thereby supply the gas to the shot area while moving it.

### BACKGROUND OF THE INVENTION

1. Field of the Invention

The present invention relates to an imprinting method for transferring a nano-scale fine pattern formed on a mask to a resin applied on a substrate.

2. Description of the Related Art

Imprinting technology is a technology that enables transferring a nano-scale fine pattern, and is being practically implemented as one of the nano-lithography technologies for facilitating the mass production of magnetic storage media and semiconductor devices. In imprinting technology, a mold (mask) on which a fine pattern is formed using an electron beam lithography system or the like is employed as an original plate to thereby transfer the pattern onto a substrate such as a silicon substrate, a glass plate, or the like. The pattern transfer is performed by applying a resin to a substrate, and curing the resin in a state in which the mask pattern is in contact with the resin. A heat cycle method and a photo-curing method are examples of imprinting technology that has been practically implemented at the present time. In the heat cycle method, a thermoplastic resin is heated above a glass transition temperature to improve the flowability of the resin, the mask is then brought into contact with the resin on a substrate, and then the mask is released therefrom after cooling, whereby the pattern is transferred. In the photo-curing method, an ultraviolet-curable resin is exposed to ultraviolet light and cured with a mask being in contact with the resin on a substrate, and then the mask is released from the cured resin, whereby the pattern is transferred. Although the heat cycle method involves an increase in the transfer time due to temperature control and a deterioration in the dimensional accuracy due to temperature change, such problems do not exist in the photo-curing method. Thus, at present, the photo-curing method is advantageous for the mass production of nano-scale semiconductor devices.

In the past, various imprinting apparatuses have been realized depending on the resin curing method and the application. Taking only the apparatuses for the mass production of semiconductor devices or the like into consideration, the apparatuses utilizing a step and flash imprint lithography (hereinafter referred to as “SFIL”) are effective (see Japanese Patent No. 4185941).

In the SFIL, when a mask is brought into contact with a resin applied to a substrate, a pattern may undesirably be deformed if gas remains near the mask. Conventionally, a method for reducing deflection of the pattern by significantly reducing gas pockets present in a resin layer adhering to a substrate has been proposed (see Japanese Patent Laid-Open No. 2007-509769). More specifically, gas such as helium or the like, which provides at least either one of a high solubility or a high diffusibility to the aforementioned gas, may be in the state of saturation.

In an imprinting lithography apparatus, a method for guiding gas between an template and a surface with which the imprinting template is brought into contact to thereby supply gas in a direction of the normal vector extending from the pattern-formed surface has been proposed (see Japanese Patent Laid-Open No. 2009-81421).

In the prior art, it is noted that a probability of decreasing gas pockets is increased by creating turbulence in the gas flow. However, in general, the distance between the mask of an imprinting apparatus and a substrate has a small range on the order of a few millimeters. This increases pressure loss and prevents the advantageous flow of the gas. Thus, it has been a concern that the narrow space may not necessarily be filled with a predetermined gas. Also, if the inflow of the gas is repeatedly performed using the prior art or the inflow of the gas is continuously performed for a corresponding period of time, a narrow space may be filled with gas. However, in this case, the processing time required for filling the gas becomes longer, resulting in a significant decrease in productivity of the overall imprinting apparatus production.

### SUMMARY OF THE INVENTION

The present invention provides an imprinting method that is capable of filling the gap between a mask and a substrate with a gas in a short time.

According to the present invention, the gap between a mask and a substrate in an imprinting apparatus may be filled with gas having the property for reducing gas near the mask in a short time.

Further features of the present invention will become apparent from the following description of exemplary embodiments with reference to the attached drawings.

### BRIEF DESCRIPTION OF THE DRAWINGS

FIG. 1 is a schematic view illustrating the configuration of an imprinting apparatus that is capable of executing the imprinting method according to the present invention.

FIG. 2 is a diagram illustrating the relationships between a resin application device, a nozzle, and a shot position.

FIG. 3 is a schematic view illustrating the sequence of an imprinting method to be performed by a twin-stage type imprinting exposure apparatus.

FIG. 4 is a schematic view illustrating the sequence of an imprinting method according to a first embodiment.

FIG. 5 is a schematic view illustrating the sequence of an imprinting method according to a second embodiment.

FIG. 6 is a schematic view illustrating the sequence of an imprinting method according to a third embodiment.

FIG. 7 is a schematic view illustrating the sequence of an imprinting method according to a fourth embodiment.

### DESCRIPTION OF THE EMBODIMENTS

Hereinafter, an imprinting method according to the present invention will now be described with reference to the accompanying drawings. While the embodiments to be described below are preferred specific embodiments of the imprinting method of the present invention, various limitations suitable for the technical configuration may be provided. However, the technical scope of the present invention may not be limited to these embodiments as long as there is no special description to limit the present invention. Also the components of the embodiments to be described below may be substituted for existing components as appropriate, and various modifications of combinations of other existing components may be made. Therefore, the context of the present invention as defined in the appended claims is not to be limited by the description of embodiments to be described below. Throughout the drawings, the same components are denoted by the same reference numerals and the duplicate description thereof is omitted.

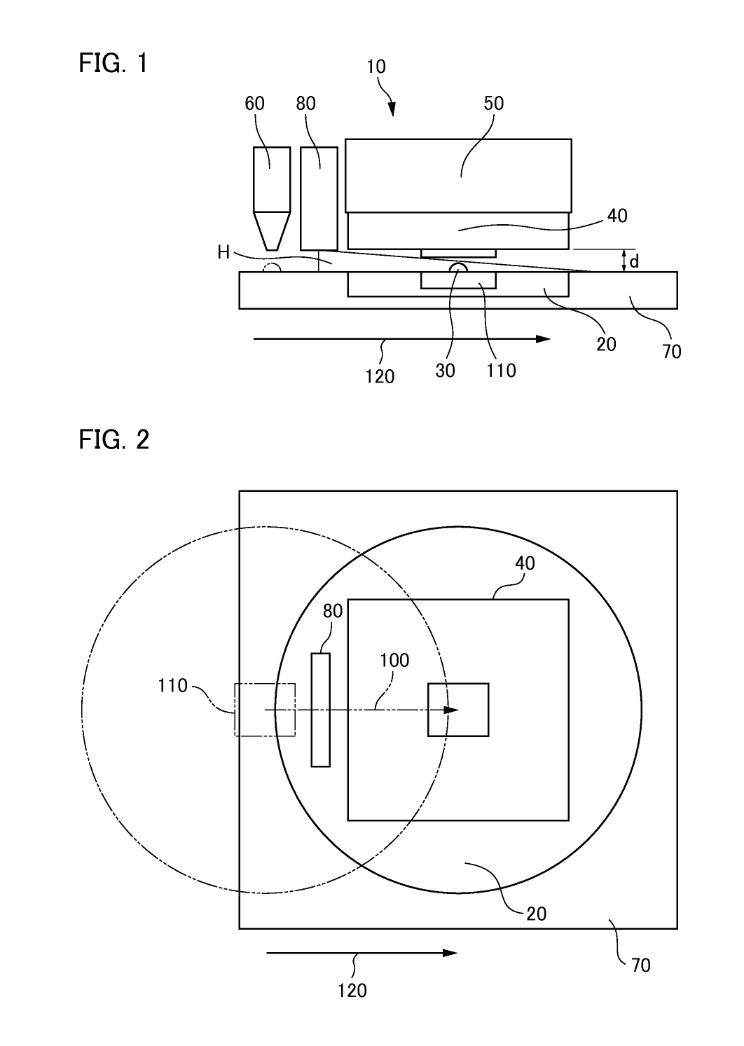

With reference to FIG. 1, the reference number 10 is an imprinting apparatus that is capable of executing the imprinting method of the present invention. In an imprinting apparatus 10, a resin application device 60 applies a resin 30 to a shot area 110 of a substrate 20. The substrate 20 on which the resin 30 is applied is moved in a driving direction 120 to the shot position (imprinting) using a substrate stage 70 that holds the substrate 20. The shot position is located directly below a mask 40 that is held by an imprinting head 50 of the imprinting apparatus 10. When the shot area 110 of the substrate 20 on which the resin 30 is applied is moved directly below the mask 40, the mask 40 is brought into contact with the resin 30. The resin 30 is cured under this condition, and the mask 40 is then released from the resin 30, whereby a pattern is transferred onto a substrate 40.

When the mask 40 is brought into contact with the resin 30, a pattern may undesirably be deformed if gas remains near the mask 40. In order to decrease the gas, a gas “H”, which provides at least either one of a high solubility or a high diffusibility to the resin 30, may be supplied to the substrate 20 on which the resin 30 is applied so as to be the state of saturation. Examples of the gas “H” having such a property include helium and the like. In order to supply the gas “H” to a gap “d” between the mask 40 and the substrate 20, which has moved to the shot position, the imprinting apparatus 10 has a gas supply nozzle 80. Note that the distance of the gap “d” to which the gas “H” is supplied is, for example, in the range of from 0.1 to 10 mm.

With reference to FIG. 2, the arrangement position of the gas supply nozzle 80 of the imprinting apparatus 10, a timing at which the gas “H” supply is started, the size and the shape of the gas supply nozzle 80 will be described. The gas supply nozzle 80 is arranged on a movement path from the position at which the resin 30 is applied to the shot area 110 of the substrate 20 to the shot position directly below the mask. Also, the timing at which the gas “H” supply is started is just before the shot area 110 of the substrate 20 passes through the gas supply nozzle 80 arranged on the movement path. The aforementioned arrangement position and timing allow the gas “H” on the substrate to be drawn along accompanying the movement of the substrate 20 due to its viscosity. As described above, the substrate 20 is moved to the shot position directly below the mask using the substrate stage 70, whereby the gas “H” may be supplied to the gap “d” in an excellent manner.

In consideration of the throughput of the imprinting apparatus 10, it is preferable for the imprinting method according to the present invention that the distance over which the substrate 20 on which the gas “H” has been supplied is moved to the shot position is short. Thus, the driving direction 120 of the substrate stage 70, i.e., the path extending from the position at which the resin 30 is applied to substrate 20 using the resin application device 60 through the supply position of the gas supply nozzle 80 to the shot position, is typically linear. However, if the supply width of the gas supply nozzle 80 is less than the width of the shot area 110, there may be an area in which the gas “H” is not directly supplied to the shot area 110. Thus, it is desirable that the size of the gas supply nozzle 80 be bigger than that of the shot area 110. The shape of the supply port of the gas supply nozzle 80 may be any one which is provided a plurality of openings. Examples of which include a slit-like shape, a porous plate, or the like.

The flow of gas according to the movement of the substrate 20 is thought to be approximated by a so-called “Couette flow” which may be seen when one of the two parallel plates is fixed while moving the other. Thus, the gas “H” to the extent assumed by Couette flow is filled with the gap “d” between the mask 40 and the substrate 20 according to the movement of the substrate stage 70 holding the substrate 20. However, if the supply flow rate of the gas “H” is insufficient, the ambient atmosphere may be entrained according to the movement of the substrate stage 70, whereby the atmosphere may undesirably flow into the gap “d”, which is to be filled with the gas “H”. Thus, it is desirable that the flow rate Q (m³/s) of the gas “H” to be supplied satisfy the relationship of the following formula:

[Formula 1]

Q≧1/2*s*d*L/t

where the shot width of the pattern is s (m), the gap between the mask 40 and the substrate 20 is d (m), the driving distance of the substrate stage 70 is L (m), and the drive time of the substrate stage 70 is t (s). If the gas “H” is supplied so as to satisfy the relationship shown by the formula (1), the atmosphere is not entrained according to the movement of the substrate stage 70, whereby the gap “d” may only be filled with the gas “H”.

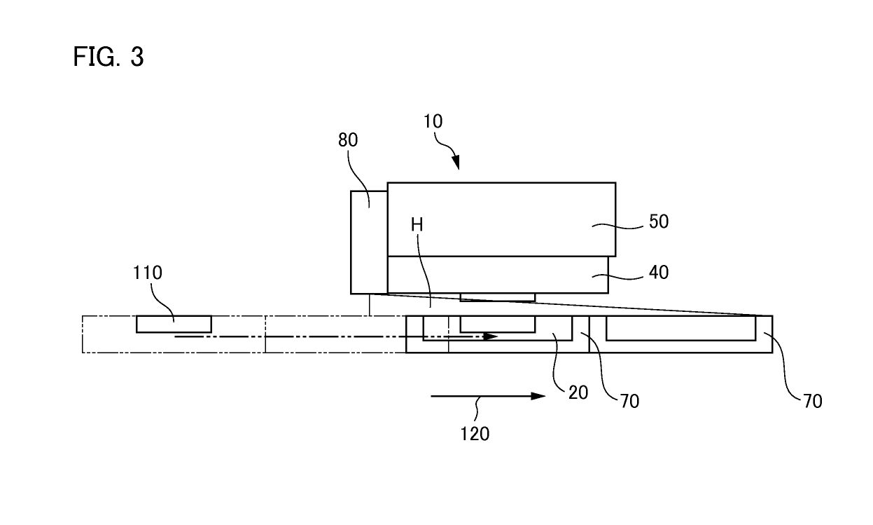

Note that the imprinting method according to the present invention is also applicable to the twin-stage type imprinting exposure apparatus disclosed in Japanese Patent Laid-Open No. 2000-505958 or the like. Hereinafter, a twin-stage type imprinting exposure apparatus will be described with reference to FIG. 3. In the twin-stage type exposure apparatus, two substrate stages 70 each for holding the substrate 20 are brought into proximity. When the twin-stage is driven, the distance which the substrate 20 directly below the gas supply nozzle 80 moves until the shot area 110 reaches the shot position directly below the mask 40 may substantially be doubled. When a single-stage type exposure apparatus having only one substrate stage 70 is employed, the size of the substrate stage 70 must be doubled to perform the same function. In the present embodiment, the concentration of the gas “H” directly below the mask 40 can be readily increased without being affected by the disadvantage.

### FIRST EMBODIMENT

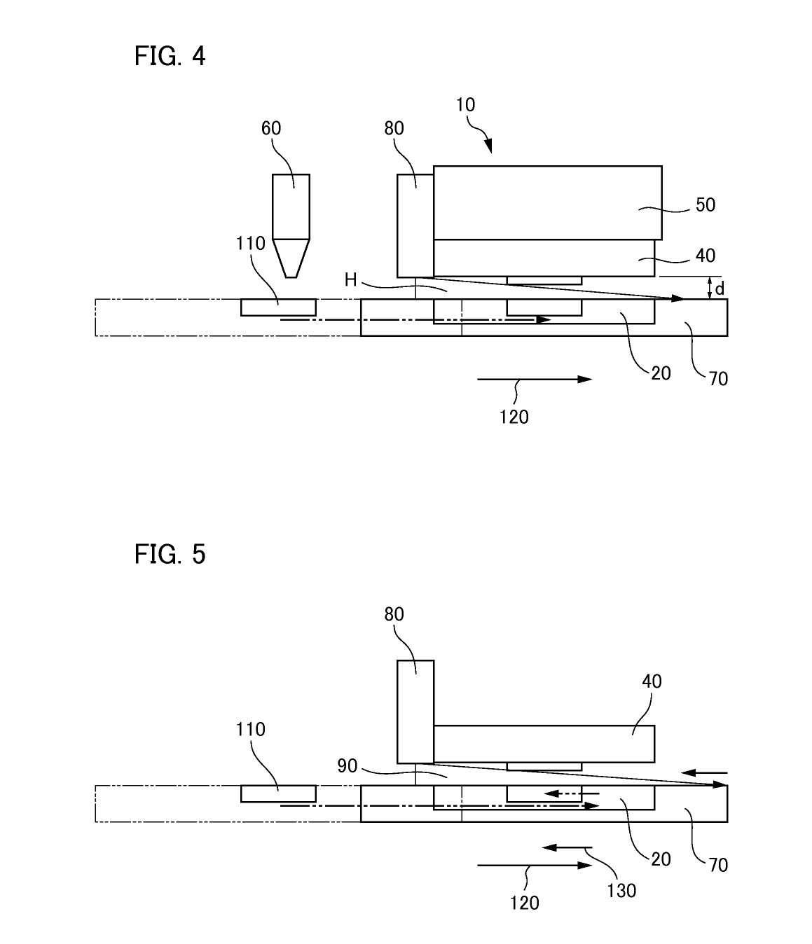

An imprinting method of a first embodiment will be described with reference to FIG. 4. It is preferable that the gas “H” to be supplied from the gas supply nozzle 80 is supplied at a high concentration to the gap “d” between the mask 40 and the substrate 20.

As described above, the flow of the gas “H” is approximated by the Couette flow between the fixed mask 40 and the substrate stage 70. Thus, the gas “H” is caused to flow into the gap “d” immediately after the gas “H” has been supplied to the shot area 110 of the substrate 20, and the concentration of the gas “H” filled in the gap “d” becomes higher when the movement distance of the shot area 110 after passing through the shot position of the shot area 110 becomes longer. Thus, in the first embodiment, the gas supply nozzle 80 is arranged at a position as near to the mask 40 as possible.

### Second Embodiment

An imprinting method of a second embodiment will be described with reference to FIG. 5. In the second embodiment, after the shot area 110 of the substrate 20 has passed through the shot position towards the driving direction 120, the substrate stage is made so as to return the shot area 110 back to the shot position again toward a reverse direction 130. By means of such process, the motion distance of the shot area 110 after passing through the shot position becomes longer, whereby the concentration of the gas “H” in the gap “d” may be increased.

### Third Embodiment

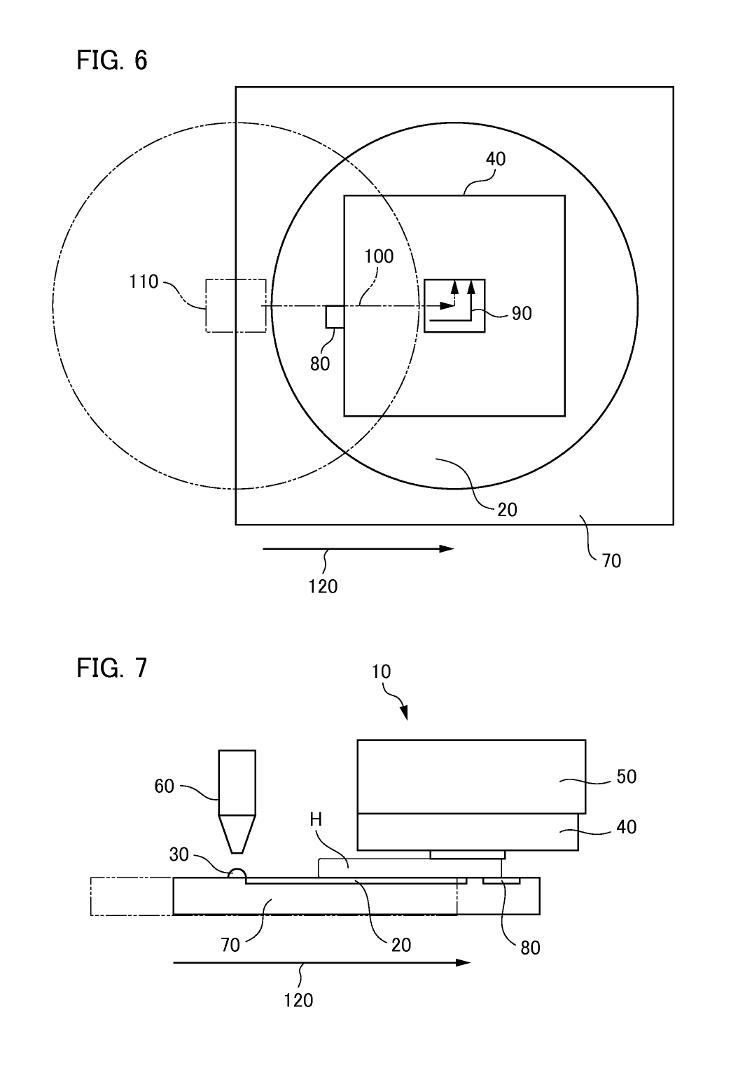

An imprinting method of a third embodiment will be described with reference to FIG. 6. In the third embodiment, a description will be given of a method for the case that the size of the gas supply nozzle 80 cannot be greater than that of the shot area 110 as shown in FIG. 2. When the width of the gas supply nozzle 80 is smaller than that of the shot area 110, an area in which the gas “H” is not directly supplied may be produced. Consequently, the variation in the concentration of the gas “H” immediately after being supplied may occur, and thus, it is difficult to increase the concentration of the gas “H” in the gap “d”. Thus, in the third embodiment, after the shot area 110 of the substrate 20 has moved to the shot position, the shot area 110 is moved by changing the orientation of the shot area 110 by 90 degrees with respect to the driving direction 120. By moving the shot area 110 of the substrate 20 in this way, even when the width of the gas supply nozzle 80 cannot be greater than that of the shot area 110, the gap “d” in the shot position may be filled with the gas “H” in sufficient concentration.

Although there are two directions that change the orientation of the shot area 110 by 90 degrees with respect to the driving direction 120, which direction the orientation of the shot area 110 is changed may be determined depending on the arrangement position of the gas supply nozzle 80. For example, when the gas supply nozzle 80 is eccentrically arranged to one end side of the shot position so as to supply the gas “H”, the orientation of the shot area 110 may be changed by 90 degrees towards the other end side opposite to the one end.

### Fourth Embodiment

An imprinting method of a fourth embodiment will be described with reference to FIG. 7. In the first to third embodiments, the gas supply nozzle 80 is arranged on a path of the driving direction 120 of the substrate stage 70 so as to supply the gas “H” to the substrate 20 from above. The fourth embodiment is different from these embodiments in that the gas supply nozzle 80 is arranged on the substrate stage 70.

In general, the shot position is present at the center portion of the mask 40 having a predetermined size. As in the first embodiment, even when the gas supply nozzle 80 attempts to be brought closer to the mask 40, the gas supply nozzle 80 cannot be brought closer than a predetermined distance because the predetermined size of the mask 40 may set a limitation. In such a case, the size limitation may be overcome by opening the supply port of the gas “H” at a portion other than the portion at which the pattern of the mask 40 is formed. However, such processing may lead to an increase in the production cost of the mask 40.

Accordingly, in the fourth embodiment, the gas supply nozzle 80 is arranged on the substrate stage 70 such that the gas supply nozzle 80 is brought closer to the mask 40 without any limitation on the size of the mask 40. The gas supply nozzle 80 is capable of supplying the gas “H” from the gas supply nozzle 80 provided in the substrate stage 70 onto the substrate 20 during the movement of the shot area 110 of the substrate 20 from the position at which the resin 30 has been applied to the substrate 20 to the shot position. The fourth embodiment is particularly useful when the concentration of the gas “H” in the shot area needs to be readily increased upon imprinting process on a shot area closer to the outer periphery of the substrate 20.

Although the present invention has been described in terms of preferred embodiments, naturaly the present invention is not limited to these embodiments but may be modified or changed in various ways within the scope of the present invention.

(Article Manufacturing Method)

Next, a method of manufacturing a device (semiconductor device, liquid crystal display device, and the like) as an embodiment of the present invention is described. The semiconductor device is manufactured through a front-end process in which an integrated circuit is formed on a wafer, and a back-end process in which an integrated circuit chip is completed as a product from the integrated circuit on the wafer formed in the front-end process. The front-end process includes a step of exposing a wafer coated with a photoresist to light using the above-described exposure apparatus of the present invention, and a step of developing the exposed wafer. The back-end process includes an assembly step (dicing and bonding), and a packaging step (sealing). The liquid crystal display device is manufactured through a process in which a transparent electrode is formed. The process of forming a plurality of transparent electrodes includes a step of coating a glass substrate with a transparent conductive film deposited thereon with a photoresist, a step of exposing the glass substrate coated with the photoresist to light using the above-described exposure apparatus, and a step of developing the exposed glass substrate. The device manufacturing method of this embodiment has an advantage, as compared with a conventional device manufacturing method, in at least one of performance, quality, productivity and production cost of a device.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-224819 filed Oct. 4, 2010 which is hereby incorporated by reference herein in its entirety.

What is claimed is:

1. An imprinting method for transferring a pattern formed on a mold to a substrate, the imprinting method comprising:
applying a resin to a predetermined shot area on the substrate;
moving the shot area from an application position to an imprinting position;
supplying gas, in a gas supply step, to the shot area; and
imprinting the mold into the shot area;
wherein, in the gas supply step, gas is supplied only from a gas supplying unit located above a moving path extending from the application position to the imprinting position, and the supply of the gas is started before the shot area passes beneath the gas supplying unit to thereby supply the gas to the shot area while moving it.

2. The imprinting method according to claim 1, wherein, after the shot area to which the gas has been supplied has passed through the imprinting position, the shot area is moved so as to be returned back to the imprinting position.

3. The imprinting method according to claim 1, wherein, after the shot area to which the gas has been supplied has moved to the imprinting position, the shot area is moved by changing the orientation thereof by 90 degrees with respect to the moved direction.

4. An imprinting method for transferring a pattern formed on a mold to a substrate, the imprinting method comprising:
applying a resin to a predetermined shot area on the substrate;
moving the shot area from an application position to an imprinting position;
supplying gas, in a gas supply step, from a gas supplying unit provided on a substrate stage for mounting the substrate; and
imprinting the mold into the shot area;
wherein, in the gas supply step, the gas is supplied from the gas supplying unit while moving the shot area from the application position to the imprinting position.

5. The imprinting method according to claim 1, the method comprising:
a substrate stage for mounting and moving the substrate,
wherein the flow rate Q (m³/s) of the gas to be supplied satisfies the relationship of the following formula:
[Formula 1]
Q≧1/2*s*d*L/t
where the shot width of the pattern is s (m), the gap between the mask and the substrate is d (m), the driving distance of the substrate stage is L (m), and the drive time of the substrate stage is t (s).

6. An article manufacturing method comprising:
forming, in a resin pattern forming step, a resin pattern; and
processing a substrate on which the pattern is formed by the resin pattern forming step,
wherein the resin pattern forming step employs an imprinting method for transferring a pattern formed on a mold to a substrate, the imprinting method comprises:
applying a resin to a predetermined shot area on the substrate;
moving the shot area from an application position to an imprinting position;
supplying gas, in a gas supply step, to the shot area; and
imprinting the mold into the shot area;
wherein, in the gas supply step, gas is supplied only from a gas supplying unit located above a moving path extending from the application position to the imprinting position, and the supply of the gas is started before the shot area passes beneath the gas supplying unit to thereby supply the gas to the shot area while moving it.
